(19) United States
(12) Patent Application Publication
(10) Pub. No.: US 2024/0309183 A1
(43) Pub. Date: Sep. 19, 2024

(54) Controlled Atmosphere Fresh-Keeping Film and Application therefor

(71) Applicant: SHAOXING XINKAIJI NEW MATERIAL CO., LTD, Shaoxing (CN)

(72) Inventor: Ke MA, Shaoxing (CN)

(73) Assignee: SHAOXING XINKAIJI NEW MATERIAL CO., LTD, Shaoxing (CN)

(21) Appl. No.: 18/221,915

(22) Filed: Jul. 14, 2023

Related U.S. Application Data
(63) Continuation of application No. PCT/CN2023/081793, filed on Mar. 16, 2023.

(51) Int. Cl. C08L 23/06; C08J 5/18

(52) U.S. Cl. CPC C08L 23/06; C08J 5/18; C08J 2323/06; C08J 2423/06; C08J 2423/08; C08L 2205/025; C08L 2205/03

(57) ABSTRACT

Disclosed in the present application are a controlled atmosphere fresh-keeping film and an application therefor. Raw material compositions of the controlled atmosphere fresh-keeping film include hyperbranched polyethylene, branched polyethylene, and polyethylene vinyl acetate resin; and in parts by mass, the hyperbranched polyethylene is 15-45 parts, the branched polyethylene is 25-55 parts, and the polyethylene vinyl acetate resin is 15-40 parts. By using the fresh-keeping film processed through the raw material formula of the present application, O₂ and CO₂ permeability is guaranteed, and a water permeable structure of the fresh-keeping film is changed, such that a certain humidity environment can be guaranteed in a package space to maintain the survival of fruits and vegetables, and water vapor generated by the fruits and vegetables during a respiration process can also be guaranteed to be discharged outside the packaging.

### TECHNICAL FIELD

The present application belongs to the technical field of fresh-keeping films, and specifically, to a controlled atmosphere fresh-keeping film and an application therefor.

### BACKGROUND

Post-harvest decay of fruits and vegetables is a global problem. In the world, about 25% of fruit and vegetable products cannot be used due to decay and spoilage, while the loss rate of some perishable fruits and vegetables is even up to more than 30%. According to statistics, the post-harvest loss rate of fruits in China is about 25%, and that of vegetables is up to 40% to 50%, which translates into an economic value of about 75 billion yuan. The deterioration of the fruits and vegetables is mainly because of effects such as respiration of the fruits and vegetables, evaporation, growth of microorganisms, and oxidation or browning of food ingredients; and these effects are closely related to environmental gases in which food is stored, such as O₂, CO₂, moisture and temperature. Fresh fruits still undergo vigorous metabolic reactions after being picked up, while there will also be evaporation of moisture, consumption of its own sugar and nutrients, decomposition of CO₂, moisture and heat, resulting in loss of nutrients and deterioration of taste and flavor, such that the edible value of the fruits is reduced, and storage resistance and disease resistance are also reduced. Therefore, in addition to using low-temperature storage to reduce physiological activity, reduce respiration, reduce the loss of nutrients, if the gas content and relative humidity of a food storage environment can be controlled, and an environment with a low oxygen (generally the content of O₂ being 1%-5%) and appropriate CO₂ concentration is created to control the factors of food deterioration, so as to maintain normal life activities, ensure disease resistance and maximize the inhibition of respiration, so that the purpose of prolonging the shelf life or storage period of food may be achieved. A controlled atmosphere technology (which is to reduce an oxygen concentration and increase the concentration of carbon dioxide) may help inhibiting the respiration of the fruits and vegetables and prolonging the fresh-keeping time of the fruits and vegetables. The effect of the technology in fruit storage has been widely recognized by the industry.

In another aspect, for the control of relative humidity in a storage environment of the fruits and vegetables, that is, the water permeability of fresh-keeping films, as water vapor is a polar substance, while oxygen and carbon dioxide are non-polar substances, the fresh-keeping films of the controlled atmosphere technology used in the related art cannot achieve the purpose of simultaneous permeation of the water vapor and the oxygen and carbon dioxide.

Therefore, silicon windows or micro-perforations in the films are used in the related art for achieving the above purpose. However, the silicon windows can only achieve limited local permeability, the fruits and vegetables away from the silicon windows will still be rotted due to local water accumulation; and although the micro-perforations can achieve uniform permeability, but bacteria or viruses are also very easy to enter through the micro-perforations, and the fruits and vegetables are rotted caused by secondary infection. In addition, in the related art, there are also ways to achieve dehumidification by placing a water-absorbent material in fresh-keeping bags, for example, a layer of the fruits and vegetables and a layer of water-absorbent material, but this not only causes cumbersome packaging and high costs, but also leads to wastes of storage space.

In view of the above situations, the present application is intended to adjust the structure of a fresh-keeping film by changing the formulation of the fresh-keeping film to synchronously realize the air permeability and water permeability of the fresh-keeping film, so as to prolong the fresh-keeping time of the fruits and vegetables.

### SUMMARY

In order to overcome the disadvantages of the related art, the present application provides a controlled atmosphere fresh-keeping film, and an application of the controlled atmosphere fresh-keeping film in fresh-keeping of fruits and vegetables.

The present application uses the following technical solutions to resolve the technical problems.

A controlled atmosphere fresh-keeping film, of which raw material compositions include hyperbranched polyethylene, branched polyethylene, and polyethylene vinyl acetate resin, herein in parts by mass, the hyperbranched polyethylene is 15-45 parts, the branched polyethylene is 25-55 parts, and the polyethylene vinyl acetate resin is 15-40 parts.

Preferably, the hyperbranched polyethylene is 25-35 parts, the branched polyethylene is 35-45 parts, and the polyethylene vinyl acetate resin is 20-30 parts.

Preferably, the hyperbranched polyethylene is 35 parts, the branched polyethylene is 40 parts, and the polyethylene vinyl acetate resin is 25 parts.

The application further provides an application of the controlled atmosphere fresh-keeping film which is used to package and store the fruits and vegetables.

The present application has the following beneficial effects.

According to the technical solution of the present application, a three-dimensional reticulated gas channel is built for a fresh-keeping film by using the hyperbranched polyethylene as a basic material. The hyperbranched polyethylene has a uniformly-distributed short branched chain structure, and has no long branched chain structure, such that after processing, no crystallization region is formed to affect a gas permeation rate. The crystallinity of the polyethylene is reduced by adjusting the compositions of the hyperbranched polyethylene and the branched polyethylene. Carbon dioxide and oxygen permeation amounts are guaranteed by adjusting the compositions of the hyperbranched polyethylene and the branched polyethylene by forming the gas channel through branches of polyethylene. The polyethylene vinyl acetate resin in a raw material formula may form a sea-island structure on the fresh-keeping film after being processed, such that the density distribution of the sea-island structure may be adjusted by adjusting the use amount of the polyethylene vinyl acetate resin, so as to regulate a permeability rate of the fresh-keeping film. By using the fresh-keeping film processed through the raw material formula of the present application, O₂ and CO₂ permeability is guaranteed, and a water permeable structure of the fresh-keeping film is changed, such that a certain humidity environment can be guaranteed in a package space to maintain the survival of the fruits and vegetables, and water vapor generated by the fruits and vegetables during a respiration process can also be guaranteed to be discharged outside the packaging. Therefore, the water permeable structure of the fresh-keeping film in the related art is prevented from causing secondary pollution on the fruits and vegetables while ensuring continuous uniform water permeability.

In the present application, the structure of the fresh-keeping film is adjusted by changing the formulation of the fresh-keeping film to synchronously realize the air permeability and water permeability of the fresh-keeping film, so as to effectively prolong the fresh-keeping time of the fruits and vegetables.

### BRIEF DESCRIPTION OF THE DRAWINGS

FIG. 1A is a picture of pakchoi before storage.

FIG. 1B is a picture of pakchoi after being stored for a month by using a fresh-keeping film of Embodiment 1 in a sealed manner at 5° C.

FIG. 2A is a picture of baby cucumbers before storage.

FIG. 2B is an appearance picture of baby cucumbers after being stored for a month by using a fresh-keeping film of Embodiment 1 in a sealed manner at 5° C.

FIG. 2C is a picture of the baby cucumbers of FIG. 2B after being cut open.

FIG. 3A is a picture of litchis before storage.

FIG. 3B is an appearance picture of litchis after being stored for a month by using a fresh-keeping film of Embodiment 1 in a sealed manner at 5° C.

FIG. 3C is a picture showing a fresh-keeping effect of litchi pulp of FIG. 3B.

FIG. 4A is a picture of red plums before storage.

FIG. 4B is an appearance picture of red plums after being stored for a month by using a fresh-keeping film of Embodiment 1 in a sealed manner at 5° C.

FIG. 4C is a picture showing a fresh-keeping effect of red plum flesh of FIG. 4B.

FIG. 5 is an electron microscope diagram of a fresh-keeping film of Embodiment 1.

### DETAILED DESCRIPTION OF THE EMBODIMENTS

The present application provides a controlled atmosphere fresh-keeping film, of which raw material compositions include hyperbranched polyethylene, branched polyethylene, and polyethylene vinyl acetate resin, herein in parts by mass, the hyperbranched polyethylene is 15-45 parts, the branched polyethylene is 25-55 parts, and the polyethylene vinyl acetate resin is 15-40 parts.

Preferably, the hyperbranched polyethylene is 25-35 parts, the branched polyethylene is 35-45 parts, and the polyethylene vinyl acetate resin is 20-30 parts.

Main factors affecting the air permeability of polyethylene are: the category, number and distribution of branched chains, molecular weight and molecular weight distribution; and among the above, the type and number of the branched chains have more influence on the performance. The polyethylene is a crystalline polymer, and the crystallinity of the polyethylene varies with different densities. The crystallinity is linearly related to the density, and has a significant effect on many properties of the polyethylene. In views of the presence of short branched chains of the polyethylene interfering with the crystallization of a main chain, the addition of the short branched chains disrupts the crystallization and reduces the density. Homopolymerized High Density Polyethylene (HDPE) contains very few short branched chains, such that the high density polyethylene has high crystallinity and high density. Although Linear Low Density Polyethylene (LLDPE) and the HDPE both belong to linear polyethylene, the LLDPE is totally formed by copolymerization of ethylene and α-olefin. Since the LLDPE contains more copolymer monomers than the high-density copolymers, there are many short branched chains on a linear main chain of the LLDPE, resulting in low crystallinity and density. In addition, as the category and number of the short branched chains vary with different copolymer monomers, if the copolymer monomer has more carbon atoms and is highly presented in the copolymer, the density of the copolymer decreases greatly. The relationship between the air permeability and density of the polyethylene is that an increase in density causes an increase in a crystal barrier layer and a consequent decrease in air permeability. Compared with other plastic thin films, a polyethylene thin film is more permeable to nitrogen, oxygen and carbon dioxide, and in particular, the LLDPE is more permeable than thin films such as polystyrene, polyvinyl chloride and polyethylene terephthalate. The air permeability of various media for ethylene is greatly related to the solubility of the media in ethylene; and generally, the air permeability of non-polar substances is greater than that of polar substances. Therefore, in the present application, the crystallinity of the polyethylene is reduced by adjusting the compositions of the hyperbranched polyethylene and the branched polyethylene, so as to guarantee the air permeability of the thin film; and carbon dioxide and oxygen permeation amounts are guaranteed by forming a gas channel through the branches of the polyethylene.

Further, generally, water vapor is a polar substance, while oxygen and carbon dioxide are non-polar substances, both of which require special design in film formulation and structure to achieve permeability. A three-dimensional reticulated gas channel is built for a film by using the hyperbranched polyethylene as a basic material. The hyperbranched polyethylene has a uniformly-distributed short branched chain structure, and has no long branched chain structure, such that after processing, no crystallization region is formed. The crystallization region has great influence on gas permeation, thus greatly reducing the permeability of the oxygen and carbon dioxide.

In addition, polyvinyl acetate resin has a very good water vapor permeation rate due to the presence of ester groups. However, if the polyvinyl acetate resin is used alone, a film cannot be completely formed when an addition exceeds 5% as the compatibility of the polyvinyl acetate resin with polyethylene resin is too poor, such that the processing cannot be realized. The polyethylene vinyl acetate resin has improved compatibility with the polyethylene due to the presence of a polyethylene structure, making it possible to produce and process the film. Therefore, the polyethylene vinyl acetate resin is selected to form a sea-island structure on the film, and the permeation rate is adjusted through the density distribution of the sea-island structure.

The technical solution of the present application is further described in detail below with reference to the drawings and embodiments. It is understood that, the present application is not limited by the specific embodiments disclosed below, and it should be known to those skilled in the art that improvements or transformations made without departing from the spirit of the present application should still be covered by the scope of protection of the present application.

Embodiment 1, raw materials of the controlled atmosphere fresh-keeping film are prepared in parts by mass below.

| | |
|---|---|
| Hyperbranched polyethylene | 35 parts |
| Branched polyethylenee | 40 parts |
| Polyethylene vinyl acetate resin | 25 parts |

Resin particles are mixed; and the controlled atmosphere fresh-keeping film with a film thickness being 28 μm is prepared by using a fresh-keeping film blowing process in the related art (that is, preparation is performed by using a screw extrusion film blowing machine).

Related performance indicators of the obtained film are measured; herein, for methods for measuring CO₂ permeability and O₂ permeability, refer to GB/T1038-2000 plastic thin film and sheet gas permeability test method pressure difference methods; and for a method for measuring a water vapor permeation rate, refer to GB/T1037-2021 plastic thin film and sheet water vapor permeation performance measurement cup weight gain and loss methods. Measured performance indicator results are as follows. In addition, for ease of comparison, performance indicators of a fresh-keeping film with considerable air permeability in the related art are also given below.

| | | CO₂ | O₂ | Water |
|---|---|---|---|---|
| | | permeability | permeability | vapor |
| | | (cm³/m² · | (cm³/m² · | permeability |
| | | 24 h · | 24 h · | (g/m² · |
| | Thickness | 0.1 MPa) | 0.1 MPa) | 24 h) |
| Embodiment 1 | 28 μm | 12049.87 | 7329.83 | 25.12 |
| Fresh-keeping | 28 μm | 12870.21 | 6898.76 | 0.23 |
| film in the | | | | |
| related art | | | | |

It may be learned from data in the table that, by comparing the fresh-keeping film of Embodiment 1 with a fresh-keeping film in the related art, when air permeability is comparable, the water vapor permeability of Embodiment 1 of the present application is significantly improved, such that the fresh-keeping film has excellent air permeability and water permeability at the same time.

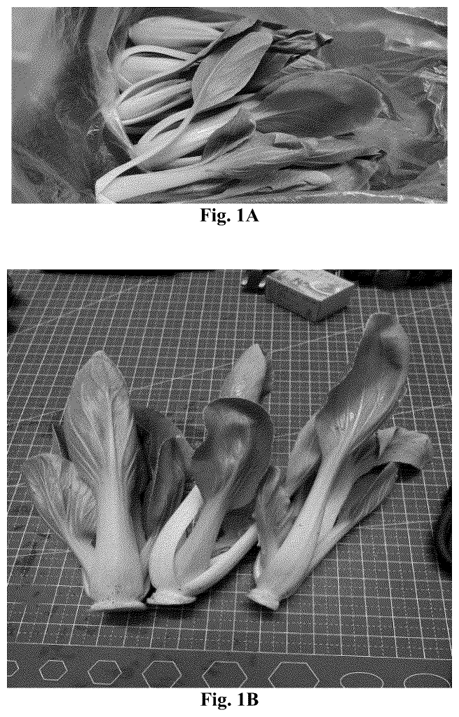

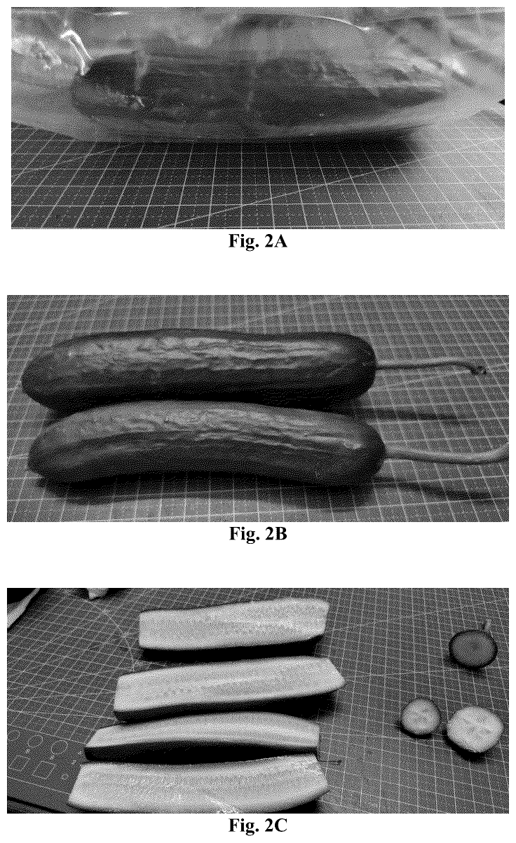

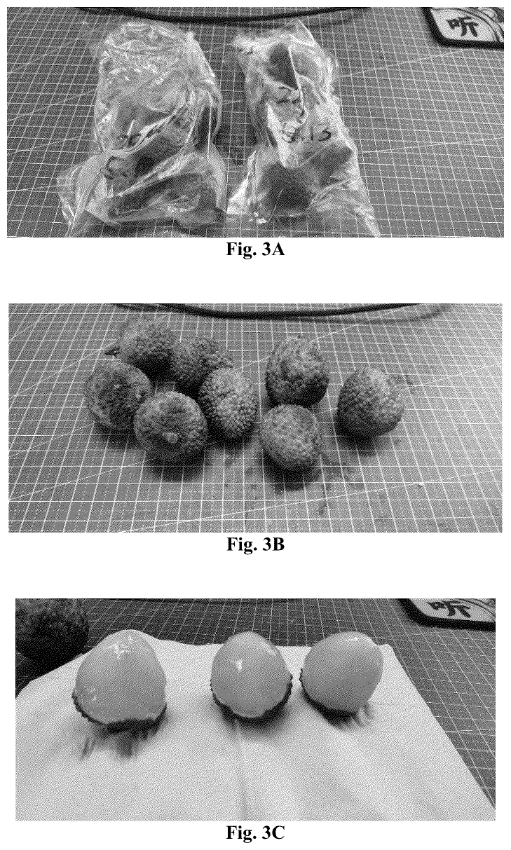

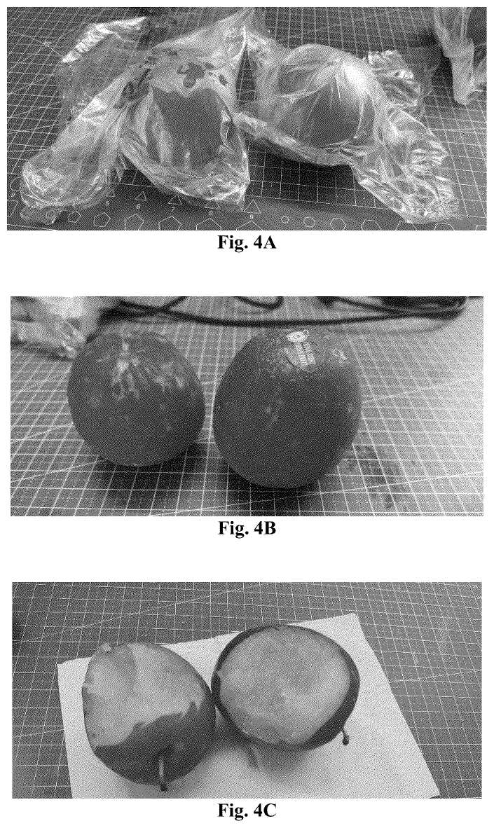

The fresh-keeping film of Embodiment 1 is used to perform a storage experiment of vegetables and fruits, and obtained experimental results are shown in FIG. 1 to FIG. 4. It may be seen from the figures that, after 1 month of refrigerated storage of the vegetables, yellow leaves, withering or localized decay does not occur. After 1 month of refrigerated storage of the fruits, there is no obvious withering on surfaces, and the flesh of the fruits still retains a certain amount of water content and is not diseased.

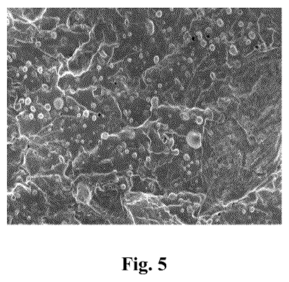

FIG. 5 is an electron microscope diagram of Embodiment 1. The picture is generated by a SEM5000 scanning electron microscope of CIQTEK. The sea-island structure may be obviously seen through the electron microscope diagram, and the size and distribution of the sea-island structure are relatively uniform.

The difference between Embodiments 2-7 and Embodiment 1 lies in the mass part of raw materials, while the processing processes and film performance indicator measurement methods are all the same as Embodiment 1.

Embodiment 2, raw materials of the controlled atmosphere fresh-keeping film are prepared in parts by mass below.

| | |
|---|---|
| Hyperbranched polyethylene | 35 parts |
| Branched polyethylenee | 25 parts |
| Polyethylene vinyl acetate resin | 40 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 9283.26 | 5589.63 | 38.68 |

Embodiment 3, raw materials of the controlled atmosphere fresh-keeping film are prepared in parts by mass below.

| | |
|---|---|
| Hyperbranched polyethylene | 35 parts |
| Branched polyethylenee | 45 parts |
| Polyethylene vinyl acetate resin | 20 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 13079.96 | 7709.79 | 20.62 |

Embodiment 4, raw materials of the controlled atmosphere fresh-keeping film are prepared in parts by mass below.

| | |
|---|---|
| Hyperbranched polyethylene | 45 parts |
| Branched polyethylenee | 40 parts |
| Polyethylene vinyl acetate resin | 15 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 14873.46 | 8289.10 | 13.62 |

Embodiment 5, raw materials of the controlled atmosphere fresh-keeping film are prepared in parts by mass below.

| | |
|---|---|
| Hyperbranched polyethylene | 40 parts |
| Branched polyethylenee | 30 parts |
| Polyethylene vinyl acetate resin | 30 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 11059.00 | 7589.79 | 30.13 |

Embodiment 6, raw materials of the controlled atmosphere fresh-keeping film are prepared in parts by mass below.

| | |
|---|---|
| Hyperbranched polyethylene | 15 parts |
| Branched polyethylenee | 55 parts |
| Polyethylene vinyl acetate resin | 30 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 8134.56 | 4765.26 | 29.23 |

Embodiment 7, raw materials of the controlled atmosphere fresh-keeping film are prepared in parts by mass below.

| | |
|---|---|
| Hyperbranched polyethylene | 25 parts |
| Branched polyethylenee | 35 parts |
| Polyethylene vinyl acetate resin | 40 parts |

The controlled atmosphere fresh-keeping film with a film thickness being 28 μm is prepared, and measured performance indicator results are as follows.

| | CO₂ permeability | O₂ permeability | Water vapor |
|---|---|---|---|
| | (cm³/m² · | (cm³/m² · | permeability |
| Thickness | 24 h · 0.1 MPa) | 24 h · 0.1 MPa) | (g/m² · 24 h) |
| 28 μm | 8914.67 | 6312.23 | 35.52 |

It may be learned from the above embodiments that, by using the controlled atmosphere fresh-keeping film prepared through the raw material formula of the technical solution of the present application, the air permeability and water permeability of the fresh-keeping film can be realized simultaneously, and demands of different fruits and vegetables are met, such that the fresh-keeping time of the fruits and vegetables is prolonged, thereby achieving the purpose of prolonging a storage period.

According to the technical solution of the present application, a three-dimensional reticulated gas channel is built for a fresh-keeping film by using the hyperbranched polyethylene as a basic material. The hyperbranched polyethylene has a uniformly-distributed short branched chain structure, and has no long branched chain structure, such that after processing, no crystallization region is formed to affect a gas permeation rate. The crystallinity of the polyethylene is reduced by adjusting the compositions of the hyperbranched polyethylene and the branched polyethylene. Carbon dioxide and oxygen permeation amounts are guaranteed by adjusting the compositions of the hyperbranched polyethylene and the branched polyethylene by forming the gas channel through branches of polyethylene. The polyethylene vinyl acetate resin in a raw material formula may form a sea-island structure on the fresh-keeping film after being processed, such that the density distribution of the sea-island structure may be adjusted by adjusting the use amount of the polyethylene vinyl acetate resin, so as to regulate a permeability rate of the fresh-keeping film. By using the fresh-keeping film processed through the raw material formula of the present application, O₂ and CO₂ permeability is guaranteed, and a water permeable structure of the fresh-keeping film is changed, such that a certain humidity environment can be guaranteed in a package space to maintain the survival of the fruits and vegetables, and the water vapor generated by the fruits and vegetables during a respiration process can also be guaranteed to be discharged outside the packaging. Therefore, the water permeable structure of the fresh-keeping film in the related art is prevented from causing secondary pollution on the fruits and vegetables while ensuring continuous uniform water permeability. By using the fresh-keeping film processed through the raw material formula of the present application, the air permeability and water permeability of the fresh-keeping film are realized simultaneously, such that the fresh-keeping time of the fruits and vegetables can be effectively prolonged.

1. A controlled atmosphere fresh-keeping film, wherein raw material compositions of the controlled atmosphere fresh-keeping film comprise hyperbranched polyethylene, branched polyethylene, and polyethylene vinyl acetate resin, wherein
in parts by mass, the hyperbranched polyethylene is 15-45 parts, the branched polyethylene is 25-55 parts, and the polyethylene vinyl acetate resin is 15-40 parts.

2. The controlled atmosphere fresh-keeping film as claimed in claim 1, wherein the hyperbranched polyethylene is 25-35 parts, the branched polyethylene is 35-45 parts, and the polyethylene vinyl acetate resin is 20-30 parts.

3. The controlled atmosphere fresh-keeping film as claimed in claim 1, wherein the hyperbranched polyethylene is 35 parts, the branched polyethylene is 40 parts, and the polyethylene vinyl acetate resin is 25 parts.

4. An application of the controlled atmosphere fresh-keeping film as claimed in claim 1, wherein the controlled atmosphere fresh-keeping film is used to package and store fruits and vegetables.
